(19) United States
(12) Patent Application Publication
(10) Pub. No.: US 2013/0066687 A1
(43) Pub. Date: Mar. 14, 2013

(54) SYSTEM AND METHOD FOR MEASURING AND MANAGING INNOVATION PERFORMANCE

(71) Applicant: Vikas Dewangan, Maharashtra (IN)

(72) Inventor: Vikas Dewangan, Maharashtra (IN)

(73) Assignee: Infosys Limited, Bangalore (IN)

(21) Appl. No.: 13/619,863

(22) Filed: Sep. 14, 2012

(30) Foreign Application Priority Data
Sep. 14, 2011 (IN) 3153/CHE/2011

(51) Int. Cl. G06Q 10/00

(52) U.S. Cl. 705/7.39

(57) ABSTRACT

A system and method of measuring innovation performance comprises creating a performance record on a network device, wherein the performance record is stored in a memory. The performance record includes a plurality of life cycle stages and perspective factors for each life cycle stage. One or more performance goals and associated key performance indicators (KPIs) and corresponding values are retrieved for performance participants. The KPIs and corresponding values are associated with one or more corresponding perspective factors and/or life cycle stages. The retrieved KPIs and corresponding values are compiled and then displayed in a customizable dashboard report in association with the performance record.

### RELATED APPLICATION

The present application claims the benefit of priority under 35 U.S.C. 119 on Indian Patent Application Serial No. 3153/CHE/2011, filed Sep. 14, 2011, and entitled “System And Method For Measuring And Managing Innovation Performance”, commonly owned herewith.

### FIELD

The present disclosure relates to a system and method for holistically measuring performance and managing innovation using a customizable displayable dashboard tool.

### BACKGROUND

Organizations or enterprises appreciate the importance of investing in innovation. However, they are not always methodical when it comes to measuring the performance of their innovation processes and outcomes. In this context, an organization trying to improve its innovation processes, which does not have access to a robust innovation performance measurement system that identifies the areas where the organization's innovation processes has a weakness and can thus be improved.

Existing software systems which measure innovation performance of the organization have been typically concerned with identifying individual innovation performance indicators without much focus on a lifecycle based performance measurement approach. This is disadvantageous for the organization as existing software solutions may not identify the specific life cycle stage(s) where a problem or potential improvement area exists. Accordingly, existing software solutions may not provide the needed information to enable the organization to find the best approach for taking corrective action to improve its innovation processes.

What is needed is a system and method which overcomes these shortcomings

### SUMMARY

In an aspect, a method of measuring innovation performance is described.

The method comprises retrieving, via a user interface, information regarding one or more user identified performance participants associated with a innovation process. The method comprises creating, utilizing one or more processors, a performance record of the innovation process, wherein the performance record includes a plurality of life cycle stages and a plurality of perspective factors for each life cycle stage. The method comprises retrieving one or more key performance indicators (KPIs) and corresponding values related to one or more goals of the one or more identified performance participants. The method comprises compiling, using the one or more processors, the retrieved KPIs and the corresponding values for the one or more performance participants to the corresponding perspective factors and the life cycle stages. The method comprises displaying, via a user interface, the life stage cycles, the perspective factors and the compiled KPIs and the corresponding values in a customizable dashboard report representing the performance record.

In an aspect, a non-transitory computer readable medium having stored thereon instructions for measuring innovation performance is described. The medium comprises computer executable code, when executed by at least one machine, causes the machine to retrieve, via a user interface, information regarding one or more user identified performance participants associated with a innovation process. The code causes the machine to create a performance record of the innovation process, wherein the performance record includes a plurality of life cycle stages and a plurality of perspective factors for each life cycle stage. The code causes the machine to retrieve one or more key performance indicators (KPIs) and corresponding values related to one or more goals of the one or more identified performance participants. The code causes the machine to compile the retrieved KPIs and the corresponding values for the one or more performance participants to the corresponding perspective factors and the life cycle stages. The code causes the machine to display, via a user interface, the life stage cycles, the perspective factors and the compiled KPIs and the corresponding values in a customizable dashboard report representing the performance record.

In an aspect, a network device is described. The network device comprises a network interface that is configured to allow communications with at least one database, a memory, and a processor coupled to the network interface and the memory. The processor is operative to retrieve, via a user interface, information regarding one or more user identified performance participants associated with a innovation process. The processor is operative to create a performance record of the innovation process, wherein the performance record includes a plurality of life cycle stages and a plurality of perspective factors for each life cycle stage. The processor is operative to retrieve one or more key performance indicators (KPIs) and corresponding values related to one or more goals of the one or more identified performance participants. The processor is operative to compile the retrieved KPIs and the corresponding values for the one or more performance participants to the corresponding perspective factors and the life cycle stages. The processor is operative to display, via a user interface, the life stage cycles, the perspective factors and the compiled KPIs and the corresponding values in a customizable dashboard report representing the performance record.

In one or more of the above aspects, the dashboard report is in a form of a dashboard matrix, wherein the life cycle stages are organized in a first header array of cells, and the perspective factors are organized in a second header array of cells perpendicular to the first header array of cells. In this aspect, each KPI and the corresponding value is displayed in a cell that corresponds to a common respective life cycle stage and perspective factor.

In one or more of the above aspects, wherein life cycle stages are of a life cycle profile, wherein the life cycle profile is retrieved from the at least one database. In one or more of the above aspects, perspective factors are of a perspective profile, wherein the perspective profile is retrieved from the at least one database. In one or more of the above aspects, at least one KPI is mapped to a respective life cycle stage based on information of the performance participant's identity. In one or more of the above aspects, wherein at least one KPI is associated with information related to future performance of an associated goal, and at least one perspective factor is associated with non-financial information.

### BRIEF DESCRIPTION OF THE DRAWINGS

FIG. 1 illustrates a diagram of an example system environment that utilizes a innovation performance tool and associated method in accordance with an aspect of the present disclosure;

FIG. 2A illustrates a block diagram of a client network device implementing at least a portion of an innovation performance module in accordance with an aspect of the present disclosure;

FIG. 2B illustrate a block diagram of a server network device implementing at least a portion of the innovation performance module in accordance with an aspect of the present disclosure;

FIG. 2C illustrates an example block diagram of the innovation performance module in accordance with an aspect of the present disclosure;

FIG. 3 illustrates an example flow chart diagram depicting at least a portion of processes performed by at least the innovation performance module in accordance with an aspect of the present disclosure; and

FIG. 4 illustrates an example customizable dashboard in the form of a dashboard matrix which displays performance record in accordance with an aspect of the present disclosure.

### DETAILED DESCRIPTION

In general, a system and method of measuring innovation performance is disclosed which comprises creating a performance record on a network device, wherein the performance record is stored in a memory. The performance record includes a plurality of life cycle stages and perspective factors for each life cycle stage. One or more performance goals and associated key performance indicators (KPIs) and the corresponding values are retrieved for performance participants. The KPIs are associated with one or more corresponding perspective factors and/or life cycle stages. The retrieved KPIs and the corresponding values are compiled and then displayed in a customizable dashboard report in association with the performance record.

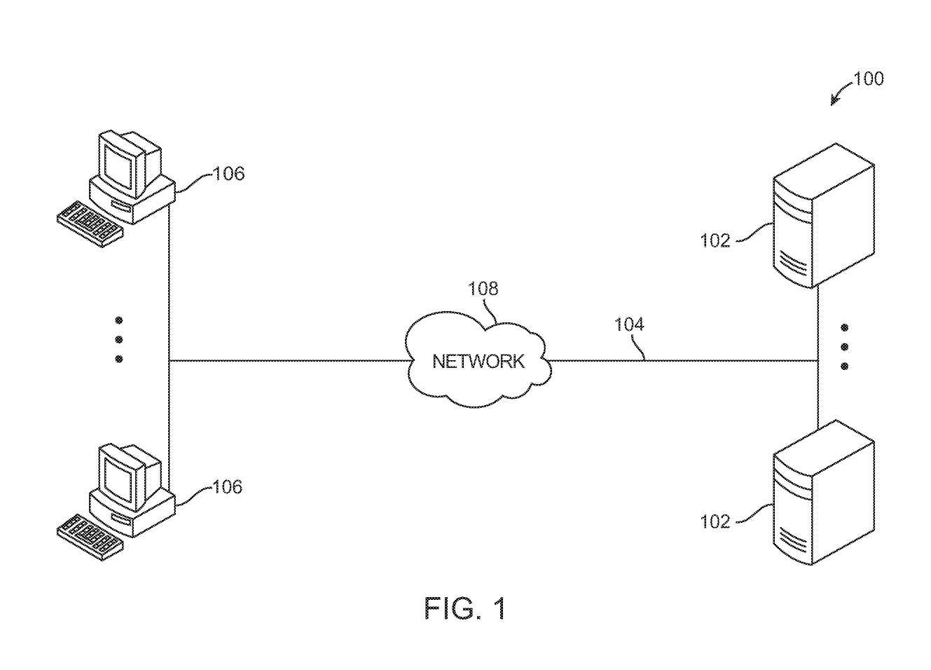

FIG. 1 illustrates a diagram of an example system environment that implements and executes a novel performance measurement and innovation management system and method in accordance with an aspect of the present disclosure. In particular, the example system environment 100 includes a plurality of network devices such as one or more servers 102(1)-102(n) and one or more client devices 106(1)-106(n), although the environment 100 could include other numbers and types of devices in other arrangements. It should be noted that the term “network devices” can be referred to as encompassing one or more client devices, one or more servers, virtual machines, cloud computing devices and/or other components in the system 100.

The servers 102(1)-102(n) are connected to a local area network (LAN) 104 and the client devices 106(1)-106(n) are connected to a wide area network 108, whereby the one or more client devices 106(1)-106(n) communicate with the one or more servers 102(1)-102(n) via the wide area network 108 and LAN 104. The servers 102(1)-102(n) comprise one or more network devices or machines capable of operating one or more Web-based and/or non Web-based applications that may be accessed by other network devices (e.g. client devices, other servers) in the network 108. One or more servers may be front end Web servers, application servers, and/or database servers. Such data includes, but is not limited to Web page(s), image(s) of physical objects, user account information, and any other objects and information. It should be noted that the servers 102(1)-102(n) may perform other tasks and provide other types of resources.

One or more servers 102 may comprise a cluster of a plurality of servers which are managed by a network traffic management device (e.g. firewall, load balancer, web accelerator), gateway device, router, hub and the like. In an aspect, one or more servers 102(1)-102(n) may implement a version of Microsoft® IIS servers, RADIUS servers and/or Apache® servers, although other types of servers may be used and other types of applications may be available the on servers 102(1)-102(n). It should be noted that although the client device and/or server may be referred to herein in the plural, it is contemplated that only one client device and/or one server may be considered without being limiting to the language used herein. It should be understood that the particular configuration of the system 100 shown in FIG. 1 are provided for exemplary purposes only and is thus not limiting.

Client devices 106(1)-106(n) comprise computing devices capable of connecting to other computing devices, such as the servers 102(1)-102(n). Such connections are performed over wired and/or wireless networks, such as network 108, to send and receive data, such as for Web-based and non Web-based requests, receiving responses to requests and/or performing other tasks, in accordance with the novel processes described herein. Non-limiting and non-exhausting examples of such client devices 106(1)-106(n) include, but are not limited to, personal computers (e.g., desktops, laptops), mobile and/or smart phones, kiosks, ATMs, tablet devices, PDAs and the like.

In an example, client devices 106(1)-106(n) may be configured to run a

Web browser or other software module that provides a user interface for human users to interact with and access the innovation performance module 220. In an example, the user can use the client device 106 to request resources and/or information, as well as submit instructions over the network 108 to the one or more servers 102(1)-102(n) via Web-based or non Web-based applications. One or more Web-based or non Web-based applications may accordingly run on the servers 102(1)-102(n) that provide the requested data to the client device 106(1)-106(n) and/or perform the requested instructions on behalf of the user. In an example, the client device 106 may be a smart phone, tablet, or smart television in which the client devices 106(1)-106(n) communicate with the servers 102(1)-102(n) via a mobile application (i.e. “mobile app”).

Network 108 comprises a publicly accessible network, such as the Internet, which handles communication between the client devices 106(1)-106(n) and the servers 102(1)-102(n). However, it is contemplated that the network 108 may comprise other types of private and public networks. Communications, such as requests from client devices 106(1)-106(n) and responses from servers 102(1)-102(n), preferably take place over the network 108 according to standard network protocols, such as the HTTP, UDP, and TCP/IP protocols and the like.

Further, it should be appreciated that the network 108 may include local area networks (LANs), wide area networks (WANs), direct connections and any combination thereof, as well as other types and numbers of network types. On an interconnected set of LANs or other networks, including those based on differing architectures and protocols, routers, switches, hubs, gateways, bridges, and other intermediate network devices may act as links within and between LANs, WANs and other networks to enable messages and other data to be sent and received between network devices. Also, communication links within and between LANs and other networks typically include twisted wire pair (e.g., Ethernet), coaxial cable, analog telephone lines, mobile cell towers, full or fractional dedicated digital lines including T1, T2, T3, and T4, Integrated Services Digital Networks (ISDNs), Digital Subscriber Lines (DSLs), wireless links including satellite links and other communications technologies.

LAN 104 may comprise one or more private and public networks which provide secured access to the servers 102(1)-102(n). These types of existing standardized messaging schemes used between financial institutions over WANs and LANs is well known and is not described in detail herein.

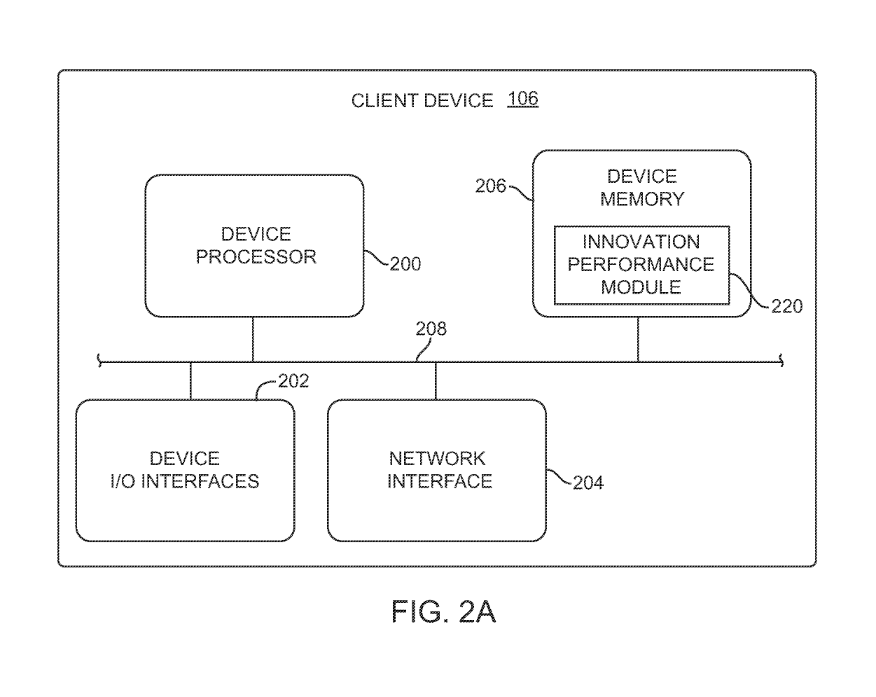

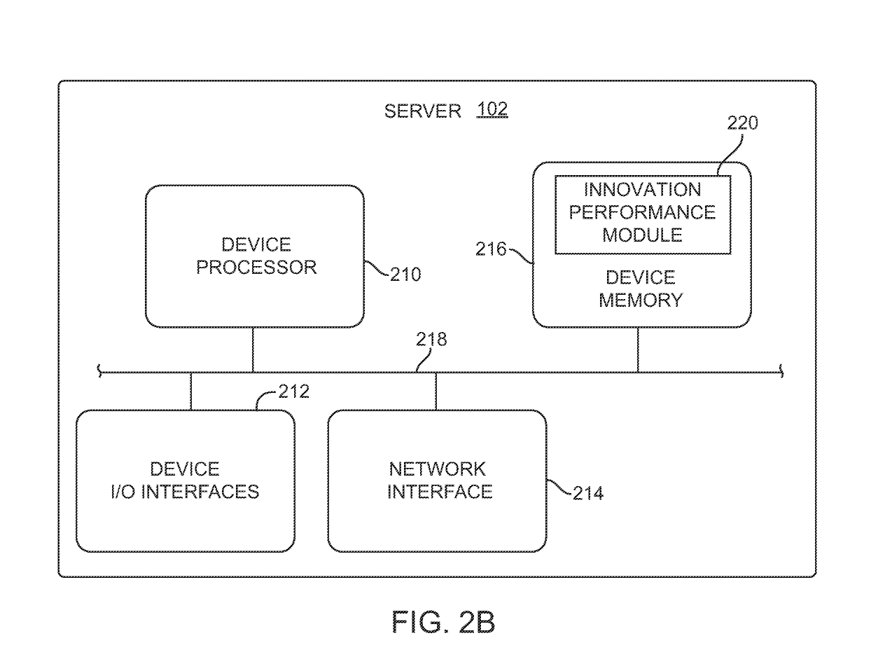

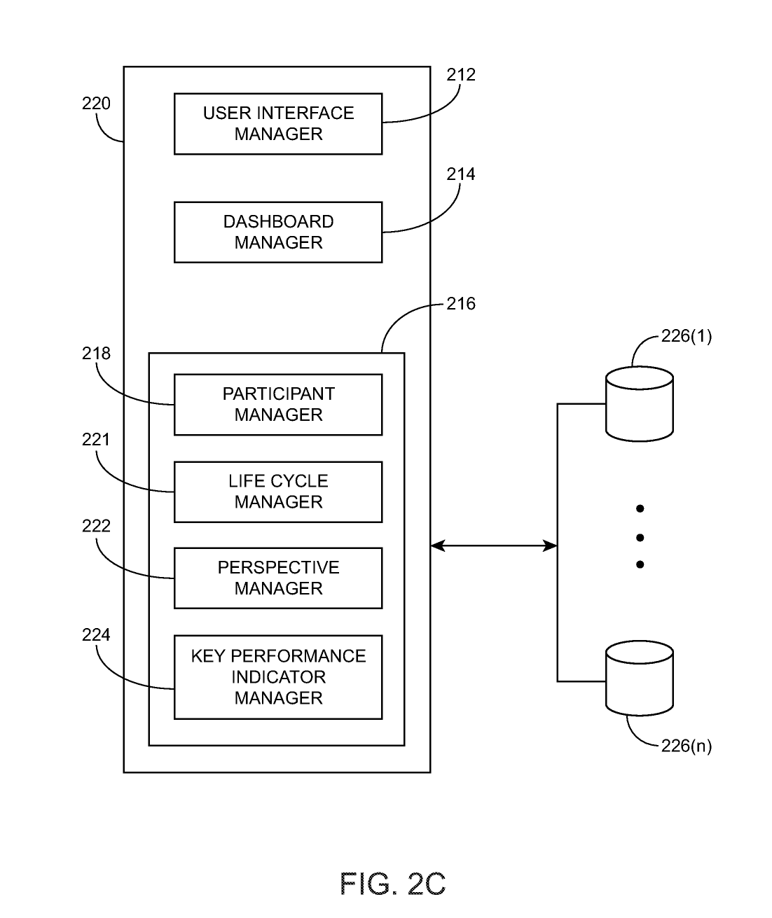

FIG. 2A illustrates a block diagram of a network client device 106 shown in FIG. 1 in accordance with an aspect of the present disclosure. As shown in FIG. 2A, an example client device 106 includes one or more device processors 200, one or more device I/O interfaces 202, one or more network interfaces 204 and one or more device memories 206, all of which are coupled together by one or more buses 208. It should be noted that the device 106 could include other types and numbers of components.

FIG. 2B illustrates a block diagram of a network device server 102 shown in FIG. 1 in accordance with an aspect of the present disclosure. With regard to FIG. 2B, an example server 102 is shown which includes one or more device processors 220, one or more device I/O interfaces 212, one or more network interfaces 214 and one or more device memories 216, all of which are coupled together by one or more buses 218. It should be noted that the server 102 could include other types and numbers of components.

Device processor 200, 210 comprises one or more microprocessors configured to execute computer/machine readable and executable instructions stored in the respective local device memory 206, 216 or in a remote device memory (not shown). Such instructions are implemented by the processor 200, 210 to perform one or more functions described below. It is understood that the processor 200, 210 may comprise other types and/or combinations of processors, such as digital signal processors, micro-controllers, application specific integrated circuits (“ASICs”), programmable logic devices (“PLDs”), field programmable logic devices (“FPLDs”), field programmable gate arrays (“FPGAs”), and the like. The processor 200, 210 is programmed or configured to execute the process in accordance with the teachings as described and illustrated herein of the novel system and method described below.

Device I/O interfaces 202, 212 comprise one or more user input and output device interface mechanisms. The interface may include a computer keyboard, touchpad, touchscreen, mouse, display device, and the corresponding physical ports and underlying supporting hardware and software to enable communications with other network devices in the system 100. Such communications include, but are not limited to, accepting user data input and providing output information to a user, programming, accessing one or more memory devices and administering one or more functions to be executed by the corresponding device and the like.

Network interface 204, 214 comprises one or more mechanisms that enable the client devices 106 and/or the servers 102 to engage in TCP/IP or other communications over the LAN 104 and network 108. However, it is contemplated that the network interface 204, 214 may be constructed for use with other communication protocols and types of networks. Network interface 204, 214 is sometimes referred to as a transceiver, transceiving device, or network interface card (NIC), which transmits and receives network data packets over one or more networks, such as LAN 104 and network 108.

In an example where the client device 106 and/or server 102 includes more than one device processor 200, 210 (or a processor 200, 210 has more than one core), each processor 200, 210 (and/or core) may use the same single network interface 204, 214 or a plurality of network interfaces 204, 214 to communicate with other network devices. Further, the network interface 204, 214 may include one or more physical ports, such as Ethernet ports, to couple its respective device with other network devices in the system 100. Moreover, the network interface 204, 214 may include certain physical ports dedicated to receiving and/or transmitting certain types of network data, such as device management related data for configuring the respective device, and the like.

Bus 208, 218 may comprise one or more internal device component communication buses, links, bridges and supporting components, such as bus controllers and/or arbiters. The bus enable the various components of the device 102, 106, such as the processor 200, 210, device I/O interfaces 202, 212, network interface 204, 214, and device memory 206, 216, to communicate with one another. However, it is contemplated that the bus may enable one or more components of its respective device 102, 106 to communicate with components in other devices as well. Example buses include HyperTransport, PCI, PCI Express, InfiniBand, USB, Firewire, Serial ATA (SATA), SCSI, IDE and AGP buses. However, it is contemplated that other types and numbers of buses may be used, whereby the particular types and arrangement of buses will depend on the particular configuration of the device 102, 106 which houses the bus.

Device memory 206, 216 of the client device 106 or server 102 comprises non-transitory computer readable media, namely computer readable or processor readable storage media, which are examples of machine-readable storage media. Computer readable storage/machine-readable storage media may include volatile, nonvolatile, removable, and non-removable media implemented in any method or technology for storage of information. Such storage media stores computer readable/machine-executable instructions, data structures, program modules and components, or other data, which may be obtained and/or executed by one or more processors, such as device processor 200, 210. Such stored instructions allow the processor to perform actions, including implementing an operating system for controlling the general operation of the client device 106 and/or server 102 to perform one or more portions of the novel process described below.

Examples of computer readable storage media include RAM, BIOS, ROM, EEPROM, flash/firmware memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Such desired information includes data and/or computer/machine-executable instructions and which can be accessed by the network devices 102, 106.

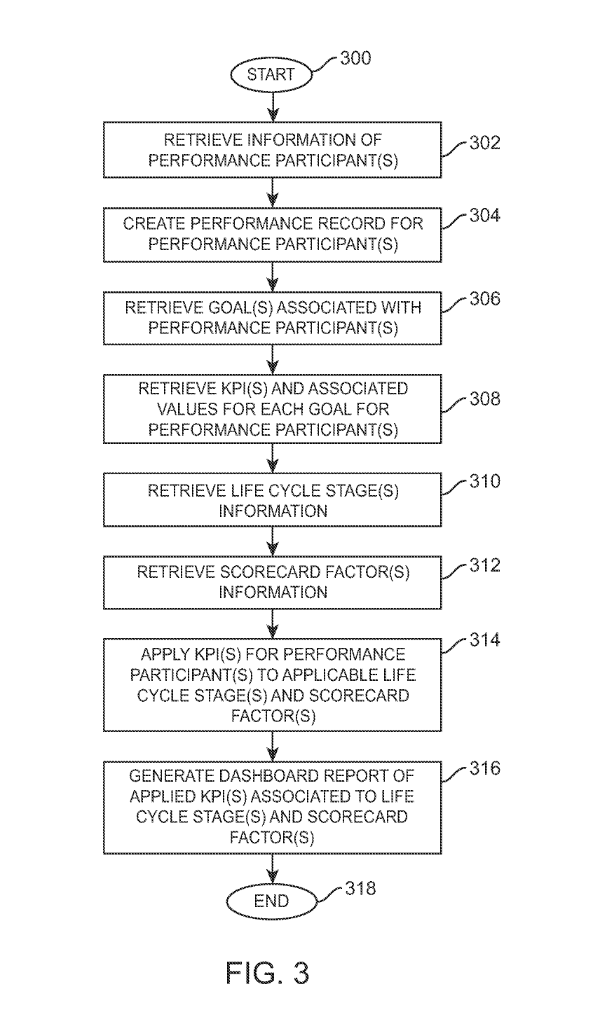

Shown in FIGS. 2A and 2B is an innovation performance module (or performance tool) 220 which comprises software, which when executed by one or more processors, causes the network device 102, 106 to perform the process described below and shown in FIG. 3. In the aspect, the innovation performance module 220 is at least partially executed on a client device 106, and is accessible by the user via a dedicated client software program. In an aspect, the innovation performance module 220 is at least partially executed on a client device 106 using a Web browser, whereby information is communicated to and from the client device, via the module 220, an appropriate module 220 on one or more servers 102. It should be noted that although the performance module is shown within memory 206, 216, it may be housed in a separate memory within or exterior to the network device 102, 106.

The performance manager 220 provides an effective customizable dashboard that provides information regarding innovation-based Key Performance Indicators (KPIs) in a comprehensive manner to one or more users. In particular, the system and method allows the organization to designate the innovation-based business process which is to be analyzed and categorizes the innovation process into a plurality of life cycle stages. Additionally, the system and method retrieves a plurality of perspective factors which are common to each of the life cycle stages. Further, the system and method retrieves KPIs for one or more relevant performance participants that have involvement in one or more of the life cycle stages and perspective factors and compiles the KPIs to the appropriate common life cycle stage(s) and perspective factor(s).

FIG. 2C illustrates an example block diagram of the innovation performance module in accordance with an aspect of the present disclosure. As shown in FIG. 2C, the innovation performance module 220 (also referred to a performance module) includes a user interface 212, a dashboard manager 214 and a performance record manager 216. In an aspect, the performance record manager 216 comprises a participant manager 218, a life cycle stage manager 221, a perspective indicator manager 222, and a key performance indicator (KPI) manager 224. As shown in FIG. 2C, the performance module 220 is configured to store and retrieve information from one or more storage devices (databases, file servers, virtual machines, etc.) 226(1)-226(n). In an aspect, the storage devices 226(1)-226(n) may comprises heterogeneous virtualized hardware devices which are accessed, through an appropriate network device, via a virtualization layer. It should be noted that the components shown in FIG. 2C are exemplary only and are used to easily describe the tools and functions of the performance module and are not to be considered limiting in any way.

The user interface manager 212 provides a user interface that is displayed on a display screen with which one or more users interface enter information needed by the performance module 220 to perform some or all of the functions described herein. The user interface 212 also operates with the dashboard manager 214 as well as the other components to allow the performance module 220 to perform some or all of the functions described herein. Additionally, the user interface 212 displays results in a report that is a customizable dashboard generated and managed by the dashboard manager 214.

The user interface manager 212 allows the user to create a new performance record to measure and analyze the performance of one or more performance participants involved in an innovation process at the organization. The performance record manager creates, manages and stores a performance record of one or more identified performance participants along with life cycle, perspective, and KPI information to which performance data is analyzed. In particular, the performance record manager 216 operates with the user interface manager 212, whereby information is provided by the user and/or is retrieved from one or more databases is handled by the performance record manager 216.

The participant manager 218 manages and coordinates information of one or more participants who are identified by the user to be relevant to the process being analyzed in the performance record. In particular, the participant manager 218 accesses the one or more databases 226(1)-226(n) to retrieve and store information of identified participants relevant to the performance record being analyzed. In an aspect, the performance participant may be a stakeholder, person, department, software, or an individual or department's role in the organization. Information of the one or more participants can be entered by the user, via the user interface, whereby the performance manager 218 stores the information in one or more appropriate databases 226(1)-226(n). Additionally or alternatively, needed information of one or more identified participants can be retrieved by the performance manager 218 from one or more appropriate databases 226(1)-226(n) and processed by the performance record manager 216.

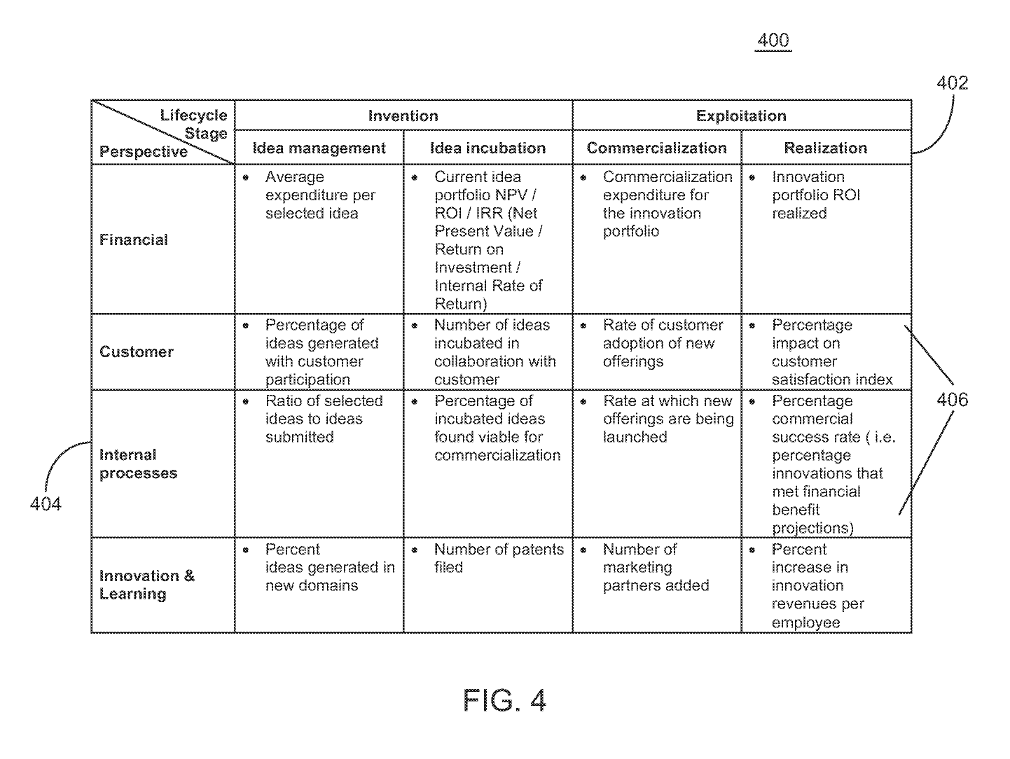

The life cycle manager 221 retrieves, manages and coordinates information of one or more life cycle stages are identified by the performance manager 220 and/or user to be relevant to the process being analyzed in the performance record. In particular, the life cycle manager 221 accesses the one or more databases 226(1)-226(n) to retrieve and/or store a life cycle profile which comprises a plurality of life cycle stages to be considered in the performance record. The user, via the user interface, can enter information of the life cycle stages are to be considered for the performance record, whereby the life cycle manager 221 stores the information in one or more appropriate databases 226(1)-226(n). Additionally or alternatively, the life cycle profile information be retrieved by the life cycle manager 221 from one or more appropriate databases 226(1)-226(n) and processed by the performance record manager 216. In an example aspect, the user may choose from one or more preset life cycle profiles that contain preset life cycle stages. In another aspect, the performance module 220 may allow the user to create a new or edit an existing life cycle profile and enter the life cycle stage(s) based on the user's and/or organization's needs. As shown in FIG. 4, an example a life cycle profile may comprise stages which include, but are not limited to, Idea Management; Idea Incubation; Idea Commercialization; and Realization. It should be noted that any number of life cycle stages and/or various names of the life cycle stages can be changed based on the user's preference.

The perspective manager 222 retrieves, manages and coordinates information of a balanced scorecard that includes one or more perspective factors that appear to be relevant to the process being analyzed in the performance record. In an aspect, the perspective manager 222 accesses the one or more databases 226(1)-226(n) to retrieve and store a perspective profile which comprises a plurality of perspective factors that are to be considered in the performance record. In an example, the user may choose from one or more preset perspective profiles that contain preset perspective factors. The user, via the user interface, can enter information of the perspective factors that are to be considered for the performance record, whereby the perspective manager 222 stores the information in one or more appropriate databases 226(1)-226(n). For example, the performance module 220 may allow the user to create a new or edit an existing perspective profile and enter the perspective factor(s) which is customized to the user's and/or organization's needs. As shown in FIG. 4, for example a balanced scorecard perspective profile may comprise perspective factors which include, but are not limited to, Financial factor; Customer factor; Internal Process factor; Innovation and Learning Factor. It should be noted that any number of perspective factors and/or various names of the perspective factors can be changed or customized based on the user's preference. In an aspect, the perspective manager 222 utilizes one or more leading and lagging factors that are considered in the analysis in the performance record.

The Key Performance Indicator (KPI) manager 224 stores, receives and coordinates information relating one or more goals which pertain to each performance participant identified for consideration in the performance record. In an aspect, the KPI manager 224 accesses the one or more databases 226(1)-226(n) to retrieve each identified performance participant's goal information as well as KPIs associated with the goal information that may be considered in the performance record. In an aspect, the user, via the user interface, can enter information of the participants' goal(s) and KPI(s) to be considered for the performance record, whereby the KPI manager 224 stores the information in one or more appropriate databases 226(1)-226(n). Additionally or alternatively, the goal(s) and KPI(s) can be retrieved by the KPI manager 224 from one or more appropriate databases 226(1)-226(n) and processed by the performance record manager 216.

The performance module 220 uses the KPI data of the corresponding participant to measure performance benchmarks. In particular, the KPIs have corresponding numeric and/or alphanumeric values which are used to track and monitor innovation performance for that particular participant as well as gauge its progress toward its designated goal using values, percentages, number of units, monetary amounts, and the like.

KPIs and their associated goals are typically defined by the performance participant(s) and/or organization. In an aspect, the performance module 220 can associate one or more KPIs to one or more perspective factors. In another aspect, the user, performance participant, and/or organization already associates one or more KPIs and the corresponding values to one or more perspective factors Some example KPIs that can be utilized by the performance module 220 include, but not are limited to: Average expenditures for commercialized/non-commercialized/incubated ideas; Percentage in revenue growth from innovations; Percentage increases in margins due to innovations; Innovation portfolio ROI realized; Revenue projections from innovations launched; Revenue projections from royalties/sale of patents; Percentage of ideas generated with customer participation; Number of ideas incubated in collaboration with customers; Rate of customer adoption of new offerings; Percentage impact on customer satisfaction index; Ratio of selected ideas to ideas submitted; Percentage of incubated ideas found viable for commercialization; Rate at which new offerings are being launched; Percentage commercial success rate; Percentage of ideas generated in new domains; Number of patents filed; Number of marketing partners added; Percentage increase in innovation revenues per employee and the like. It should be noted that the above is an example list of KPIs and is not limited thereto. It should be noted that any number of KPIs and/or their various names can be changed or customized based on the user's preference.

The dashboard manager 214 compiles and categorizes the information created, retrieved and otherwise managed by the above described components of the performance module 220 and generates a report showing a holistic and detailed analysis of all the desired metrics relating to the performance of the organization's innovation program. In an aspect, the dashboard generator organizes the report results in a customizable dashboard that is displayed to the user via the user interface. In particular aspect, the dashboard manager 214 generates the dashboard and populates it with information provided by the performance manager 216 module, whereby the designated life cycle stages and perspective factors are displayed and the retrieved KPI(s) and the corresponding values for each identified performance participant is organized and mapped to its respective life cycle stage(s) and perspective factor(s).

In an aspect, shown in FIG. 4, the dashboard manager 214 may generate a dashboard report that is in the form of a table or matrix which is customizable, sortable and/or filterable based on any user designated parameter. However, the dashboard manager 214 can provide results for the performance record by way of different charts and graphs, performance heat maps, and root cause analyses for the performance of a particular KPI. The dashboard manager 214 may be configured to provide the results by way of Ishikawa diagrams, graphical heat maps, pie charts, bar charts, fish-bone diagram, waterfall chart, calendar representation and the like.

FIG. 3 illustrates a flow chart which represents at least a portion of the process in accordance with an aspect of the present disclosure. In particular, FIG. 3 initiates at the Start Block, in which one or more users accessing the performance module 220 identifies one or more performance participants that are involved in or relevant to a business's innovation process to be analyzed (Block 302). The one or more performance participants may be identified by the user manually entering such information. In an aspect, the user may select the one or more performance participants (e.g. stakeholders, roles, software, sub-processes) from a list displayed in the user interface. In an aspect, the performance module 220 stores this information in one or more memories or databases for future use. In an aspect, the user provides preliminary information of one or more performance participants, whereby the innovation performance module 220 is able to apply logic and automatically retrieve some or all of the information needed to perform the analysis in the performance record.

The performance module 220 then creates a performance record in response to user instructions via the user interface (Block 304). The created performance record is preferably stored in a memory on the network device 102, 106 or elsewhere (e.g. or one or more databases 226(1)-226(n)).

As shown in FIG. 3, along with identifying the one or more performance participants, the performance module 220 also identifies a life cycle profile including one or more life cycle stages that are to be considered in the performance record. Again, this information can be identified manually by the user or can be automatically retrieved from one or more databases 226(1)-226(n) by the performance module 220. In an aspect, the performance module 220 stores this information in one or more memories or one or more databases 226(1)-226(n) for future use.

The performance module 220 thereafter identifies one or more goals that are associated with each identified participant and stores this information (Block 306). Again, this information can be identified manually by the user or can be automatically retrieved from one or more memories or databases 226(1)-226(n) by the performance module 220. In an aspect, the performance module 220 is able to map the one or more identified goals to either or both of one or more life cycle stages and/or one or more perspective factors. The mapping information may be entered by the user via the user interface or may be retrieved from one or more databases. In an aspect, it is contemplated that the user and/or performance module does not map the goal information with life cycle stage(s) and/or perspective factor(s), whereby the identified goals contains information which links it to either or both of the one or more life cycle stages and/or one or more perspective factors.

The performance module 220 thereafter retrieves KPIs and corresponding one or more values for each of the one or more goals associated with each identified participant and stores this information (Block 308). The KPIs can be identified manually by the user and/or can be automatically retrieved from one or more databases by the performance module 220. In an aspect, the performance module 220 is configured to map the KPIs for each of the one or more associated identified goals of the one or more identified participants to either or both of one or more life cycle stages and/or one or more perspective factors. In an aspect, it is contemplated that the user and/or performance module 220 does perform mapping logic on the KPI(s) with respect to life cycle stage(s) and/or perspective factor(s), but instead uses other information (either entered by the user or retrieved from database(s)) that allows the module 220 to apply the KPI(s) and their corresponding values to corresponding life cycle stage(s) and perspective factor(s).

In particular, based on this information, the performance module 220 selects a first life cycle stage to analyze (Block 310). In an aspect, the performance module 220 performs the analysis on each life cycle stage in the established order for the process being analyzed in relation to the performance record, although this is not required.

For the selected life cycle stage, the performance module 220 selects a first perspective factor in a scorecard balance sheet in accordance with the perspective factor profile that is utilized for the performance record (Block 312). The performance module 220 thereafter applies each KPI and the corresponding values, per participant, to the life cycle stage(s) and perspective factor(s) that the KPI is in common with and corresponds to (Block 314). In the example aspect, the performance module 220 is able to compile the mapped information for each applied KPI and the corresponding value to be able to effectively display each KPI and the corresponding value with its associated life cycle stage and perspective factor on the dashboard results, irrespective of the displayed format of the dashboard.

The performance module 220 then creates and displays, via the user interface, a fully customizable dashboard which provides a holistic and comprehensive view of all the innovation KPIs organized with respect to their appropriate common life cycle stages and perspective factors (Block 316). The process then ends at Block 318.

FIG. 4 illustrates an example dashboard in accordance with an aspect of the present disclosure. As shown in FIG. 4, the dashboard 400 is in the form of a dashboard matrix or table having a horizontal array of header cells 402, and a vertical array of header cells 404. Additionally, the dashboard matrix 400 can include a plurality of content cells 406, wherein each content cell 406 is uniquely positioned based on its particular life cycle stage and perspective factor. In this example, the KPI(s) are populated in cells 406 that correspond to intersecting or common vertical and horizontal headers. In the example shown in FIG. 4, the table 400 is configured to have four column headers 402, each of which represents a life cycle stage, whereas the table 400 has four row headers 404, each of which represents a perspective factor. In the example, the KPI shown in FIG. 4 as “Percentage impact on customer satisfaction index” as well as one or more corresponding values is placed by the module 220 in the cell 406 which is common to the “Realization” life cycle stage and the “Customer” perspective factor. It should be noted that any number of life cycle stages and perspective factors, with the same or different names, can be displayed in the matrix 400.

It should be noted that the dashboard is just an example and is configured, via the performance module 220, to be customizable based on the user preferences. For instance, the horizontal and vertical headers can be interchanged, whereby each KPI result and the corresponding value will be automatically rearranged in their proper content cell. In an aspect, the dashboard may be customized to display the KPI data in a form other than a table, as described above. In an aspect, the dashboard can be sortable based on the user's desires. In an aspect, the user, via the user interface, can choose one or more filtering features to display, whereby the dashboard manager 214 will only display the information that the user wants to view or not view. For example, the user may choose to see KPI data of one or more selected performance participants, whereby the dashboard manager 214 will only display the information for the selected participants.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A method of measuring innovation performance, the method comprising:
retrieving, via a user interface, information regarding one or more user identified performance participants associated with a innovation process;
creating, utilizing one or more processors, a performance record of the innovation process, wherein the performance record includes a plurality of life cycle stages and a plurality of perspective factors for each life cycle stage;
retrieving one or more key performance indicators (KPIs) and corresponding values related to one or more goals of the one or more identified performance participants;
compiling, using the one or more processors, the retrieved KPIs and corresponding values for the one or more performance participants to the corresponding perspective factors and the life cycle stages; and
displaying, via a user interface, the life stage cycles, the perspective factors and the compiled KPIs and corresponding values in a customizable dashboard report representing the performance record.

2. The method of claim 1, wherein the dashboard report is in a form of a matrix, wherein the life cycle stages are organized in a first header array of cells, and the perspective factors are organized in a second header array of cells perpendicular to the first header array of cells, wherein each KPI is displayed in a cell corresponding to its respective life cycle stage and perspective factor.

3. The method of claim 1, wherein life cycle stages are of a life cycle profile, wherein the life cycle profile is retrieved by the network device from one or more storage devices.

4. The method of claim 1, wherein perspective factors are of a perspective profile, wherein the perspective profile is retrieved by the network device from one or more storage devices.

5. The method of claim 1, further comprising:
mapping at least one KPI to a respective life cycle stage based on information of the performance participant's identity.

6. The method of claim 1, wherein at least one KPI is associated with information related to future performance of an associated goal.

7. The method of claim 1, wherein at least one perspective factor is associated with non-financial information.

8. A non-transitory computer readable medium having stored thereon instructions for measuring innovation performance, comprising computer executable code which when executed by at least one machine, causes the machine to:
retrieve, via a user interface, information regarding one or more user identified performance participants associated with a innovation process;
create a performance record of the innovation process, wherein the performance record includes a plurality of life cycle stages and a plurality of perspective factors for each life cycle stage;
retrieve one or more key performance indicators (KPIs) and corresponding values related to one or more goals of the one or more identified performance participants;
compile the retrieved KPIs and corresponding values for the one or more performance participants to the corresponding perspective factors and the life cycle stages; and
display, via a user interface, the life stage cycles, the perspective factors and the compiled KPIs and corresponding values in a customizable dashboard report representing the performance record.

9. The computer readable medium of claim 8, wherein the report is in a form of a matrix, wherein the life cycle stages are organized in a first header array of cells, and the perspective factors are organized in a second header array of cells perpendicular to the first header array of cells, wherein each KPI is displayed in a cell corresponding to its respective life cycle stage and perspective factor.

10. The computer readable medium of claim 8, wherein life cycle stages are of a life cycle profile, wherein the life cycle profile is retrieved by machine from at least one database.

11. The computer readable medium of claim 8, wherein perspective factors are of a perspective profile, wherein the perspective profile is retrieved by the machine from at least one database.

12. The computer readable medium of claim 8, wherein the machine is configured to:
map at least one KPI to a respective life cycle stage based on information of the performance participant's identity.

13. The computer readable medium of claim 8, wherein at least one KPI is associated with information related to future performance of an associated goal.

14. The computer readable medium of claim 8, wherein at least one perspective factor is associated with non-financial information.

15. A network device comprising:
a network interface configured to allow communications with at least one database;
a memory;
a processor coupled to the network interface and the memory, the processor operative to:
retrieve, via a user interface, information regarding one or more user identified performance participants associated with a innovation process;
create a performance record of the innovation process, wherein the performance record includes a plurality of life cycle stages and a plurality of perspective factors for each life cycle stage;
retrieve one or more key performance indicators (KPIs) and corresponding values related to one or more goals of the one or more identified performance participants;
compile the retrieved KPIs and corresponding values for the one or more performance participants to the corresponding perspective factors and the life cycle stages; and
display, via a user interface, the life stage cycles, the perspective factors and the compiled KPIs and corresponding values in a customizable dashboard report representing the performance record.

16. The network device of claim 15, wherein the dashboard report is in a form of a matrix, wherein the life cycle stages are organized in a first header array of cells, and the perspective factors are organized in a second header array of cells perpendicular to the first header array of cells, wherein each KPI is displayed in a cell corresponding to its respective life cycle stage and perspective factor.

17. The network device of claim 15, wherein life cycle stages are of a life cycle profile, wherein the life cycle profile is retrieved by the network device from the at least one database.

18. The network device of claim 15, wherein perspective factors are of a perspective profile, wherein the perspective profile is retrieved by the network device from the at least one database.

19. The network device of claim 15, wherein the processor is configured to:
map at least one KPI to a respective life cycle stage based on information of the performance participant's identity.

20. The network device of claim 15, wherein at least one KPI is associated with information related to future performance of an associated goal, and at least one perspective factor is associated with non-financial information.
